(19) United States
(12) Patent Application Publication
(10) Pub. No.: US 2025/0290615 A1
(43) Pub. Date: Sep. 18, 2025

(54) VEHICLE HEADLAMP ASSEMBLY

(71) Applicant: Hella GmbH & Co. KGaA, Lippstadt (DE)

(72) Inventors: Shyam Jayachandran, Adambakkam (IN); Karthikeyan Manoharan, Kuniyamuther (IN)

(21) Appl. No.: 19/221,738

(22) Filed: May 29, 2025

Related U.S. Application Data
(63) Continuation of application No. PCT/EP2023/083886, filed on Dec. 1, 2023.

(30) Foreign Application Priority Data
Dec. 8, 2022 (IN) 202221070787

(51) Int. Cl. F21S 41/63; F21S 45/48

(52) U.S. Cl. CPC F21S 41/635; F21S 45/48

(57) ABSTRACT

A vehicle headlamp assembly is provided with at least one lamp, a circuit board, a heatsink, an electromagnetic actuation unit, and a thermal pad arranged inside a housing. The housing has a base and a cover, defining an interior volume. The circuit board is integral to the lens module and the lamp. The electromagnetic actuation unit rotates the lens module and the circuit board to adjust the angle of deviation of the light beam from the lamp. The thermal pad is flexible enough to facilitate in rotation of the lens module and the circuit board upon actuation of the electromagnetic actuation unit.

### CROSS REFERENCE

This application claims priority to PCT Application No. PCT/EP2023/083886, filed Dec. 1, 2023, which itself claims priority to Indian Patent Application No. 202221070787, filed Dec. 8, 2022, the entireties of both of which are hereby incorporated by reference.

### FIELD OF THE INVENTION

The present invention relates to vehicle lamp assemblies. More specifically, the present invention relates to vehicle lamp assemblies with electromagnetic actuators for controlling the orientation of a vehicle lamp of the vehicle lamp assembly.

### BACKGROUND OF THE INVENTION

Headlamp assemblies in motor vehicles are usually mounted on movable frames to enable periodic adjustment of their position. The frames can be either manually or electronically tilted to achieve desired light projection. Electronic adjustment can be possible by means of a gear drive mechanism where the headlamp frame may be tilted by actuation of the gear drive mechanism. Such gear drive mechanism has complexity in design, and hence it may be challenging to assemble.

Further, it is now common to integrate a plurality of motor vehicle lighting functions in a single light module. For example, the daytime running light (DRL), the high-beam light function, and other functions are integrated into the same light module. As a result, the number of converters per module and the heat these components produce in the module increases. There is, therefore, a need for efficient heat dissipation means. The arrangement of a heat sink in the light assembly near the modules may substantially reduce heat dissipation from the light module. However, the heat sink must always be in connection or near a distance with the light module and other components to effectively dissipate heat.

When the lamp is tilted or changes the orientation of the headlamp assembly, the distance between the lamp/modules and the heat sink may increase and thus reduces the effectiveness of heat dissipation.

Therefore, there is a requirement for a vehicle headlamp assembly which overcomes a few or all the drawbacks of the present arrangement of lamp assembly in vehicles.

### OBJECTS OF THE INVENTION

An object of the present invention is to provide a headlamp assembly with an integrated lens module and circuit board.

Another object of the present invention is to provide a headlamp assembly with a flexible thermal pad, the flexibility of the thermal pad allows the circuit board and the lens module to remain connected with the heatsink to dissipate heat therefrom effectively.

Yet another object of the present invention is to provide a headlamp assembly with one or more electromagnetic coils and magnets to facilitate rotation or swivelling motion of the lens module in multiple directions, thereby helping to deviate the light beam from the lamp towards any possible direction.

Further object of the present invention is to provide a headlamp assembly, which is simple in construction and design.

Further, one more object of the present invention is to provide a headlamp assembly which is robust in construction.

### SUMMARY OF THE INVENTION

According to the present invention, there is provided with a vehicle headlamp assembly. The vehicle headlamp assembly includes at least one lamp, a lens module, a circuit board, a heatsink, an electromagnetic actuation unit and a thermal pad, all the elements being arranged inside a housing. The housing includes a base and a cover defining an interior volume. The circuit board is integral with the lens module. The circuit board is also integral with the lamp. In an embodiment of the invention, the circuit board is flexible.

In an aspect of the invention, the heatsink is arranged on the base to dissipate heat from the headlamp assembly.

The electromagnetic actuation unit is provided for rotating the lens module and the circuit board to adjust the angle of deviation of the light beam from the lamp. The electromagnetic actuation unit includes one or more pairs of electromagnetic coils mounted on the base and corresponding magnets arranged behind a flexible portion of the circuit board. The actuation of the electromagnetic coils and the magnets facilitates a swivelling movement of the lens module and the circuit board on a vertical axis or on a horizontal axis.

In an aspect of the invention, two pairs of electromagnetic coils are arranged on the base. A first electromagnetic coil and a second electromagnetic coil may be arranged on the base, and corresponding two magnets, a first magnet and a second magnet, may be arranged behind the circuit board. The first electromagnetic coil and the corresponding first magnet are arranged on the upper portion of the base and the second electromagnetic coil and the corresponding second magnet are arranged on the lower portion of the base and along a same line of axis. The actuation of the electromagnetic coils and the magnets facilitates a swivelling movement of the lens module and the circuit board on a vertical axis.

By powering up the first electromagnetic coil on the upper portion of the base to North pole to North pole and by powering up the second electromagnetic coil on the lower portion of the base to South pole to North pole with the lens module as the centre axis, the circuit board and the lens module is swivelled or rotated on a vertical axis along the direction of the force of the magnet to deviate the light beam from the lamp towards an upper side.

Further, when the first electromagnetic coil is actuated, the corresponding magnet is pulled towards the base, and when the second electromagnetic coil is actuated, the corresponding magnet is pushed away from the base resulting in the swivelling motion or rotation of the lens module and the circuit board on the vertical axis to deviate the light beam from the lamp towards the upper side, wherein if the polarities of the first electromagnetic coil and the second electromagnetic coils are reversed, the lens module and the circuit board is swivelled on the vertical axis to deviate the light beam from the lamp towards a lower side.

In another aspect, two electromagnetic coils and corresponding magnets are arranged along a horizontal axis on the upper portion of the base, and two electromagnetic coils and corresponding magnets are arranged along a horizontal axis on the lower portion of the base, the arrangement of four electromagnetic coil and corresponding magnets facilitates in the swivelling movement of the lens module and the circuit board in both vertical axis and horizontal axis depending upon the actuation of corresponding electromagnetic coils.

In such aspects, when the electromagnetic coils are actuated, the corresponding magnet is pulled towards the base and when the electromagnetic coil is actuated, the corresponding magnets are pushed away from the base resulting in the swivelling motion of the lens module and the circuit board on the vertical axis to deviate the light beam from the lamp towards an upper side wherein if the polarities are reversed, the lens module and the circuit board is swivelled on the vertical axis to deviate the light beam from the lamp towards a lower side.

If the adjacent electromagnetic coils in the upper portion of the base are powered with opposite polarities (North pole to North pole, and South pole to North pole) and the corresponding electromagnetic coils in the vertical axis on the lower portion of the base are powered with polarities North pole to North pole, and South pole to North pole, the circuit board and the lens module swivels in a horizontal axis thereby deviating the light beam from the lamp towards a left or right direction depending on the actuation of the electromagnetic coils.

Further, the circuit board is arranged on the thermal pad configured on the base. The thermal pad is adapted to absorb heat from the circuit board and the lens module. The flexibility of the thermal pad allows the circuit board and the lens module to remain closer and in connection with the heatsink while the lens module and the circuit board is swivelled/rotated in any direction. When the distance is closely maintained between the circuit board, the lens module and the heat sink while rotation of the circuit board, the heat dissipated from the circuit board and the lens module can be effectively controlled by the heat sink.

### BRIEF DESCRIPTION OF THE DRAWINGS

The advantages and features of the present invention will be understood better with reference to the following detailed description and claims taken in conjunction with the accompanying drawings, wherein like elements are identified with like symbols, and in which:

FIG. 1 shows a side view of a headlamp assembly in accordance with an embodiment of the present invention.

FIG. 2 illustrates a side view of a headlamp assembly in a rotated position in accordance with an embodiment of the present invention.

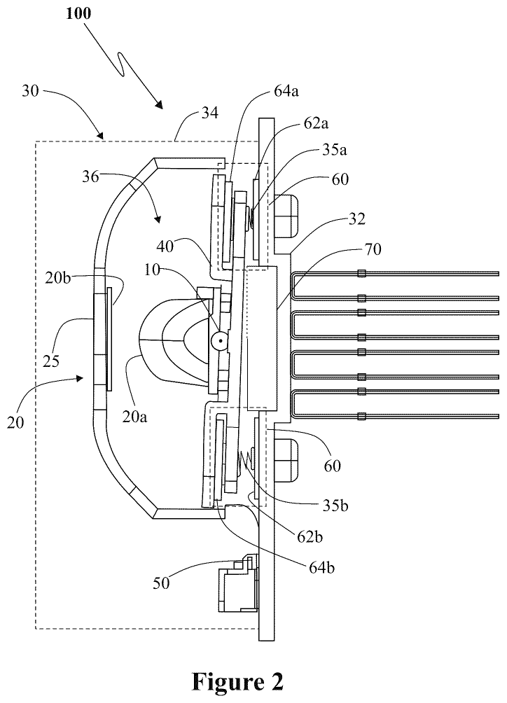

FIG. 3 illustrates an arrangement of a thermal pad on a base of the headlamp assembly.

FIG. 4 illustrates an assembled view of the headlamp assembly in accordance with an embodiment of the present invention.

FIG. 5 illustrates a second embodiment of the headlamp assembly showing the arrangement of more than one electromagnetic coil on the top and bottom portion of the base.

FIG. 6 illustrates the assembled view of FIG. 5.

### DETAIL DESCRIPTION OF THE INVENTION

An embodiment of this invention, illustrating its features, will now be described in detail. The words “comprising, “having, “containing,” and “including,” and other forms thereof, are intended to be equivalent in meaning and be open ended in that an item or items following any one of these words is not meant to be an exhaustive listing of such item or items, or meant to be limited to only the listed item or items.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced item.

The disclosed embodiments are merely exemplary of the invention, which may be embodied in various forms.

Headlamp assemblies in motor vehicles are usually mounted on movable frames to enable periodic adjustment of their position. The frames can be either tilted manually or electronically to achieve desired projection of light. However, with the increase in the function of the light module, the mechanism for tilting of light module is becoming complex. Further, due to the complexity of such mechanisms, the light module is subjected to a much heater environment resulting in poor condition of vehicle light. In order to effectively overcome the drawbacks of such a design, a headlamp assembly is proposed.

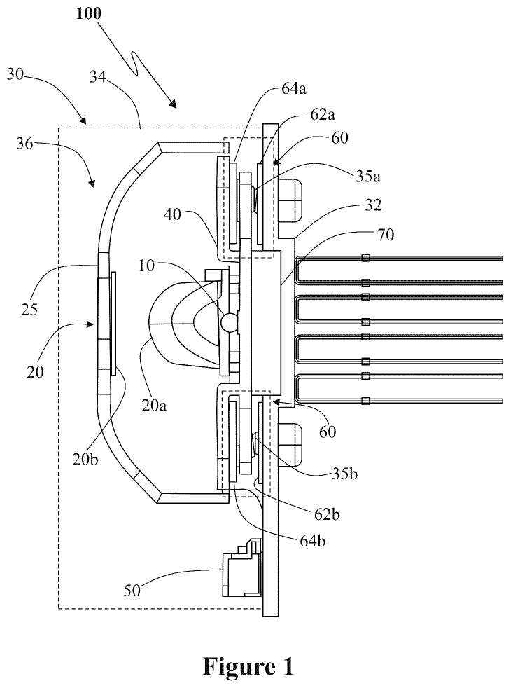

Referring to FIG. 1, a side view of a headlamp assembly (100) in accordance with the present invention is illustrated. The vehicle headlamp assembly (100) includes at least one lamp (10), a lens module (20), a circuit board (40), a heatsink (50), an electromagnetic actuation unit (60) and a thermal pad (70), all the elements being arranged inside a housing. By way of non-limiting example, the vehicle headlamp assembly (100) is shown to include only one lamp (10). In another aspect, the vehicle headlamp assembly (100) may include two or three lamps depending upon the lighting requirement. The lens module (20) has one or more lenses arranged to focus the lighting of the lamp (10) or the light source. The present embodiment is shown to provide a primary lens (20a) and a secondary lens (20b) arranged on a lens holder (25). The lens holder (25) is attachable/integral to the circuit board (40) of the vehicle headlamp assembly (100).

Referring again to FIG. 1, the housing (30) includes a base (32) and a cover (34), defining an interior volume (36). The housing (30) protects the vehicle headlamp assembly (100) from weather conditions and other dynamic vibrations caused by the movement of the vehicle. The base (32) is connected to the cover (34) by an obvious fastening member such as a nut and bolt or snap fit or weld and the like. The base (32) is a substantially flat member adapted to hold the lamp (10), the lens module (20), the circuit board (40), the heatsink (50), and the electromagnetic actuation unit (60).

Further, the circuit board (40) is connected to the lamp and the lens module (20). In the present embodiment, the circuit board (40) is a flexible circuit board. The circuit board (40) is mounted on one or more biasing members (35a, 35b), which is connected to the base (32). In the present embodiment, the biasing member (35a, 35b) is a tension spring. The biasing member (35) facilitates relative movements of the circuit board (40) and the lens module (20). For example, the biasing member (35) facilitates the movement of the circuit board (40) and the lens module (20) within an expansion or compression limit of the biasing member (35). It may be obvious to a person skilled in the art to configure any other obvious spring arrangement, such as compression spring or gas spring or the like to facilitate relative movements of the circuit board (40) and the lens module (20). The present embodiment is shown to provide two pairs of biasing members, a first pair of biasing members (35a) at an upper portion of the base (32) and a pair of second biasing members (35b) at a lower portion of the base (32). The flexibility of the circuit board (40) allows easier flexion of the circuit board (40) with respect to the biasing members (35).

Further, the heatsink (50) is arranged on the base (32) to dissipate heat from the headlamp assembly (100). The heatsink (50) may have fins or any such obvious heat-dissipating members. The present invention is shown to provide the heat sink (50) on the lower portion of the base (32). It may be obvious to a person skilled in the art to configure the heat sink (50) on any other obvious portion of the base (32).

Referring again to FIG. 1, the electromagnetic actuation unit (60) includes one or more pairs of electromagnetic coils mounted on the base (32) and corresponding magnets arranged behind a flexible portion of the circuit board (40). In a first embodiment of the invention, as shown in FIG. 1, two electromagnetic coils (62a, 62b) and respective magnets (64a, 64b) are arranged. Specifically, two electromagnetic coils, a first electromagnetic coil (62a) and a second electromagnetic coil (62b) are arranged on the base (32) and corresponding two magnets, a first magnet (64a) and a second magnet (64b) are arranged behind the circuit board (40). The first electromagnetic coil (62a) and the corresponding first magnet (64a) are arranged on the upper portion of the base (32), and the second electromagnetic coil (62b) and corresponding second magnet (64b) is arranged on the lower portion of the base (32) and along a same line of axis. The actuation of the electromagnetic coils (62a, 62b) and the magnets (64a, 64b) facilitates a swivelling movement of the lens module (30) and the circuit board (40) in a vertical axis.

By way of non-limiting example, by powering up the first electromagnetic coil (62a) on the upper portion of the base (32) to North pole to North pole and by powering up the second electromagnetic coil (62b) on the lower portion of the base (32) to South pole to North pole with the lens module as the centre axis, the circuit board (40) and the lens module (20) is swivelled or rotated on a vertical axis along the direction of the force of the magnet to deviate the light beam from the lamp (10) towards an upper side. When the first electromagnetic coil (62a) is actuated, the corresponding magnet (64a) is pulled towards the base (32), and when the second electromagnetic coil (62b) is actuated, the corresponding magnet (64b) is pushed away from the base (32) resulting in the swivelling motion of the lens module (20) and the circuit board (40) on the vertical axis to deviate the light beam from the lamp (10) towards the upper side.

Similarly, by powering up the first electromagnetic coil (62a) on the upper portion of the base (32) to South pole to North pole and by powering up the second electromagnetic coil (62b) on the lower portion of the base (32) to North pole to North pole with the lens module (20) as the centre axis, the circuit board (40) and the lens module (20) is swivelled or rotated on the vertical axis along the direction of the force of the magnet to deviate the light beam from the lamp (10) towards a lower side. When the first electromagnetic coil (62a) is actuated, the corresponding first magnet (64a) is pushed away from the base (32), and when the second electromagnetic coil (62b) is actuated, the corresponding second magnet (64b) is pulled towards the base (32) resulting in the swivelling motion of the lens module (20) and the circuit board (40) on the vertical axis to deviate the light beam from the lamp (10) towards the lower side.

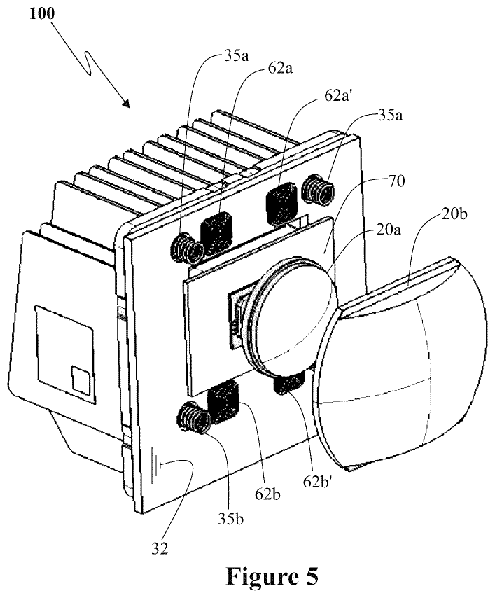

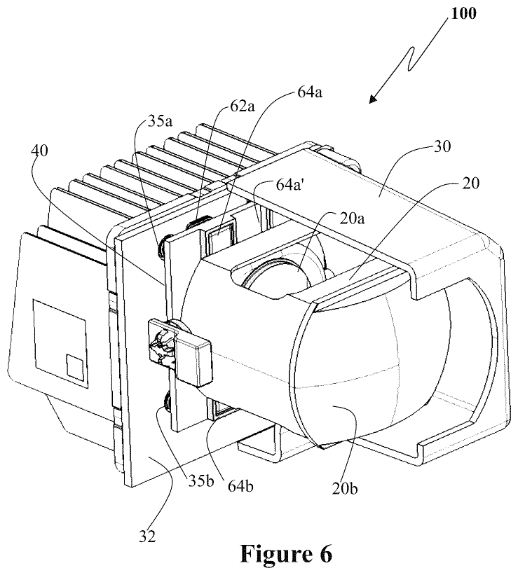

In a second embodiment, as shown in FIGS. 5 and 6, the electromagnetic actuation unit (60) includes four electromagnetic coils and four magnets. Two electromagnetic coils (62a, 62a′) and corresponding magnets (64a, 64a′) are arranged along a horizontal axis on the upper portion of the base (32), and two electromagnetic coils (62b, 62b′) and corresponding magnets (64b, 64b′) are arranged along a horizontal axis on the lower portion of the base (32). The arrangement of four electromagnetic coils (62a, 62a′, 62b, 62b′) and corresponding magnets (64a, 64a′, 64b, 64b′) facilitates a swivelling movement of the lens module (20) and the circuit board (40) in both vertical axis and horizontal axis depending upon the actuation of corresponding electromagnetic coils.

For example, when both the electromagnetic coils (62a, 62a′) on the upper portion of the base (32) are powered North pole to North pole and by powering up the electromagnetic coils (64a, 64a′) on the lower portion of the base (32) to South pole to North pole with the lens module (20) as the centre axis, the circuit board (40) and the lens module (20) is swivelled or rotated on a vertical axis along the direction of the force of the magnet to deviate the light beam from the lamp (10) towards an upper side. Specifically, when the electromagnetic coils (62a, 62a′) are actuated, the corresponding magnet (64a, 64a′) is pulled towards the base (32), and when the electromagnetic coil (62b, 62b′) is actuated, the corresponding magnets (64b, 64b′) are pushed away from the base (32) resulting in the swivelling motion of the lens module (20) and the circuit board (40) on the vertical axis to deviate the light beam from the lamp (10) towards the upper side. If the polarities are reversed, then the lens module (20) and the circuit board (40) are swivelled on the vertical axis to deviate the light beam from the lamp (10) towards the lower side.

Further, if the adjacent electromagnetic coils (62a, and 62a′) in the upper portion of the base (32) are powered with opposite polarities (North pole to North pole, and South pole to North pole) and the corresponding electromagnetic coils (62b, 62b′) in the vertical axis on the lower portion of the base (32) are powered with polarities North pole to North pole, and South pole to North pole, the circuit board (40) and the lens module (20) swivels in a horizontal axis thereby deviating the light beam from the lamp (10) towards a left or right direction depending on the actuation of the electromagnetic coils.

It may be obvious to a person skilled in the art to configure more than two electromagnetic coils and a corresponding number of magnets in the headlamp assembly (100) to swivel the lens module (20) and the circuit board (40) in various directions thereby deviating the light beam in multiple directions.

Further, when the distance is closely maintained between the circuit board (40), the lens module (20) and the heat sink (50) while swivelling motion/rotation of the circuit board (40), the heat dissipated from the circuit board (40) and the lens module (20) can be effectively controlled by the heat sink (50). The thermal pad (70) plays a pivotal role in maintaining the distance by providing flexibility to the rotation of the circuit board (40).

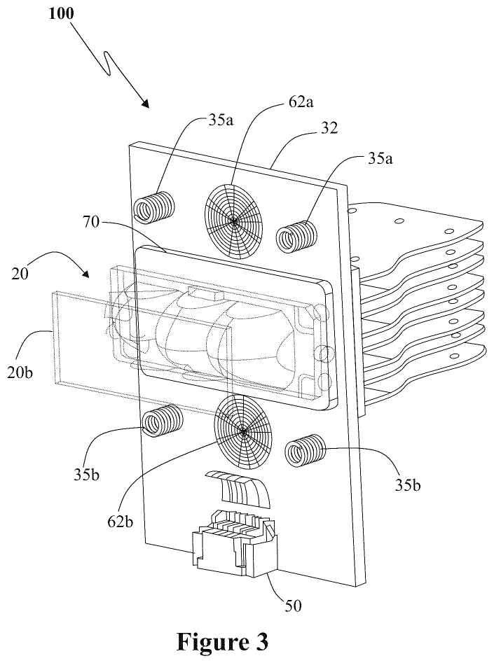

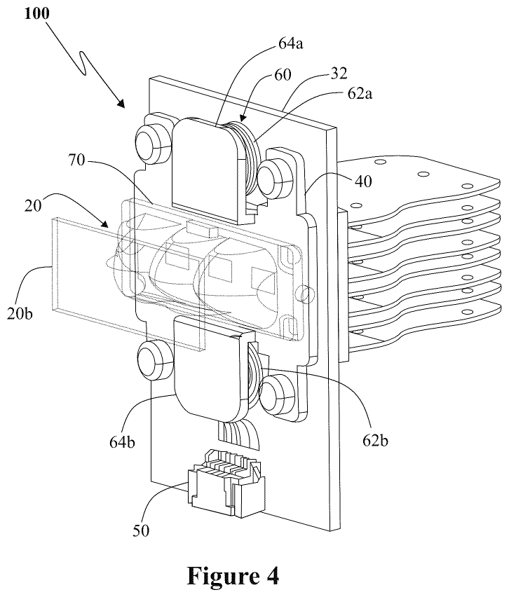

Referring now to FIGS. 3 and 4, the thermal pad (70) is arranged on the base (32) and behind the circuit board (40). The thermal pad (70) is adapted to absorb heat from the circuit board (40) and the lens module (20). In the present embodiment, the circuit board (40) is arranged/mounted on the thermal pad (70) (FIGS. 3 and 4). The thermal pad (70) is flexible enough to facilitate in rotation of the lens module (20) and the circuit board (40) upon actuation of the electromagnetic actuation unit (60). This flexibility of the thermal pad (70) allows the circuit board (40) and the lens module (20) to remain closer and in connection with the heatsink (50), while the lens module (20) and the circuit board (40) is swivelled/rotated in any directions. The thermal pad (70) can be made from silicone or any such obvious material, which makes the thermal pad (70) flexible.

Therefore, the present invention has the advantage of providing the headlamp assembly (100) with an integrated lens module and circuit board. The headlamp assembly has a flexible thermal pad to dissipate heat from the headlamp components effectively. The flexibility of the thermal pad allows the circuit board and the lens module to remain connected with the heatsink to dissipate heat therefrom effectively. The headlamp assembly is simple in construction and design. Further, the headlamp is robust in construction.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application and to thereby enable others skilled in the art to best utilise the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A vehicle headlamp assembly comprising:
at least one lamp with a lens module arranged inside a housing, the housing having a base and a cover defining an interior volume;
a circuit board integral with the lens module and the lamp;
a heatsink arranged on the base to dissipate heat from the headlamp assembly; and
an electromagnetic actuation unit for rotating the lens module and the circuit board to adjust the angle of deviation of the light beam from the lamp;
wherein the circuit board is arranged on a thermal pad configured on the base, the thermal pad being adapted to absorb heat from the circuit board and the lens module,
wherein the thermal pad is flexible enough to facilitate in rotation/swivelling movement of the lens module and the circuit board upon actuation of the electromagnetic actuation unit.

2. The vehicle headlamp assembly as claimed in claim 1, wherein the flexibility of the thermal pad allows the circuit board and the lens module to remain closer to the heatsink while the lens module and the circuit board is rotated.

3. The vehicle headlamp assembly as claimed in claim 1, wherein the circuit board is a flexible circuit board.

4. The vehicle headlamp assembly as claimed in claim 1, wherein the electromagnetic actuation unit includes one or more pairs of electromagnetic coils mounted on the base and corresponding magnets arranged behind a flexible portion of the circuit board, the actuation of the electromagnetic coils and the magnets facilitates in the rotation/swivelling movement of the lens module and the circuit board in a vertical axis or a horizontal axis.

5. The vehicle headlamp assembly as claimed in claim 4, wherein a first electromagnetic coil and a second electromagnetic coil are arranged on the base and a corresponding first magnet and second magnet are arranged behind the circuit board.

6. The vehicle headlamp assembly as claimed in claim 5, wherein by powering up the first electromagnetic coil on an upper portion of the base to North pole to North pole and by powering up the second electromagnetic coils on the lower portion of the base to South pole to North pole with the lens module as the centre axis, the circuit board and the lens module are swivelled or rotated on a vertical axis along the direction of the force of the magnet to deviate the light beam from the lamp towards an upper side.

7. The vehicle headlamp assembly as claimed in claim 6, wherein when the first electromagnetic coil is actuated, the corresponding magnet is pulled towards the base and when the second electromagnetic coil is actuated, the corresponding magnet is pushed away from the base resulting in the swivelling motion or rotation of the lens module and the circuit board on the vertical axis to deviate the light beam from the lamp towards the upper side,
wherein when the polarities of the first electromagnetic coil and the second electromagnetic coils are reversed, the lens module and the circuit board is swivelled on the vertical axis to deviate the light beam from the lamp towards a lower side.

8. The vehicle headlamp assembly as claimed in claim 4, wherein two electromagnetic coils and corresponding magnets are arranged along a horizontal axis on the upper portion of the base and two electromagnetic coils and corresponding magnets are arranged along a horizontal axis on the lower portion of the base, the arrangement of four electromagnetic coil and corresponding magnets facilitates in the swivelling movement of the lens module and the circuit board in both vertical axis and horizontal axis depending upon the actuation of corresponding electromagnetic coils.

9. The vehicle headlamp assembly as claimed in claim 8, wherein when the electromagnetic coils are actuated, the corresponding magnet are pulled towards the base, and when the electromagnetic coil is actuated, the corresponding magnets are pushed away from the base resulting in the swivelling motion of the lens module and the circuit board on the vertical axis to deviate the light beam from the lamp towards an upper side wherein when the polarities are reversed, the lens module and the circuit board is swivelled on the vertical axis to deviate the light beam from the lamp towards a lower side.

10. The vehicle headlamp assembly as claimed in claim 8, wherein when the adjacent electromagnetic coils in the upper portion of the base are powered with opposite polarities (North pole to North pole, and South pole to North pole) and the corresponding electromagnetic coils in the vertical axis on the lower portion of the base are powered with polarities North pole to North pole, and South pole to North pole, the circuit board and the lens module swivels in a horizontal axis thereby deviating the light beam from the lamp towards a left or right direction depending on the actuation of the electromagnetic coils.
